(19) United States
(12) Patent Application Publication
(10) Pub. No.: US 2013/0056988 A1
(43) Pub. Date: Mar. 7, 2013

(54) Power Generating Apparatus

(71) Applicants: David Hunt, Gainsborough (GB); James Mccague, Nottinghamshire (GB)

(72) Inventors: David Hunt, Gainsborough (GB); James Mccague, Nottinghamshire (GB)

(21) Appl. No.: 13/580,934

(22) PCT Filed: Feb. 25, 2011
(86) PCT No.: PCT/GB11/50378

§ 371 Date: Nov. 20, 2012

(30) Foreign Application Priority Data
Feb. 26, 2010 (GB) 1003349.6

(51) Int. Cl. F03B 13/16

(52) U.S. Cl. 290/53

(57) ABSTRACT

The invention relates to the use of movement of a body of water to generate electricity using apparatus which includes at least one rack member in connection with at least one rotatable means. One of the rack or rotatable means are mounted in a relatively fixed position while the other of the rack or rotatable member is mounted so as to be influenced by the movement of the body of water in which the same is located to achieve the relative movement. Means are described to allow efficient transfer of the relative movement into electricity and also to prevent damage being caused to the apparatus by excessive movement of the body of water in storm conditions.

The invention to which this application relates, is to improvements to apparatus which can be used to generate power from the movement of a body of water such as, for example, movement created by waves in the body of water, such as the sea.

The applicant, in their co-pending application WO2007125307, describes apparatus which can be used to react to the movement of a body of water to allow electrical power to be generated.

In that application, the contents of which are hereby included by reference, there is disclosed a float, which is designed to be supported by the body of water and to react to movement of the body of water, at and in the vicinity of, the surface of the same. A second assembly is provided which includes first and second, opposed rack members along which two movement means are provided to move under the influence of relative movement between the said float member and the second assembly. In one embodiment, the second assembly is provided in a fixed location and the float is provided to be moveable along the racks of the same, with said float being provided with two wheels mounted thereon, or, in an alternative embodiment, the racks can be provided to be mounted on the float and be movable with respect to a fixed assembly which has the wheels located thereon. Typically, the said toothed wheels are interconnected, via gears to a common power generating output shaft. Said toothed wheels are also interconnected via a unidirectional clutch such that movement along the racks in a first direction, causes at least one of the wheels to drive the gears and hence the common shaft and movement of the wheels along the racks in the opponent direction allows the other of the toothed wheels to drive the gears and hence common shaft. This therefore means that movement under the influence of the body of water in the first direction and in an opposing second direction, causes drive to be provided to the common shaft. The common shaft can then be connected to a generator to allow electrical power to be provided in a substantially uniform manner.

The aim of the present invention is to provide improvements to the apparatus and method as described in the applicant's co-pending application, said improvements, when adopted independently or in combination, allowing improved operation of the apparatus and/or efficiency of generation of the electricity.

In a first aspect of the invention, there is provided apparatus for generating power from the movement of a body of water, said apparatus including a first member provided to be located at, or close to, the surface of the body of water, at least one rotatable means provided for movable engagement with at least one rack member wherein one of the rotatable means or rack is connected with said first member to move under the influence of the same and to move with respect to the other of the rotatable means or rack to create a driving force and/or create power, said rack member including at least first and second rack faces, and a plurality of rotatable means are provided to move along and engage with each of said rack faces, said rotatable means connected to a gear assembly such that movement along the rack faces in a first direction causes at least one of the gears to drive an output shaft and movement in the opposing direction causes at least one of the gears to drive an output shaft wherein the output shaft or shafts are connected to create electrical power.

Typically the gear assembly includes one or more clutches to allow the drive of the output shafts by rotation of the rotatable means in both directions along the rack faces.

In one embodiment, the power which is generated is monitored such that if the level of power created falls outwith the predetermined range, power can be selectively supplied to create an electric flywheel to maintain the inertia and have supply of substantially constant electrical power to be achieved.

In one embodiment, linear guide means are provided at or adjacent to one or both of said rack faces, said guide means provided to maintain the correct tooth meshing position between the rotatable means and said rack faces during relative movement of the same.

Preferably, the linear guide means are provided on opposing sides of each of said rack faces and match with guide followers provided to act in conjunction with the rotatable means. The provision of the guide means therefore minimises the possibility of the rotatable means moving from the optimum nesting distance from the racks and hence prevent movement occurring which is out of synchronisation with the rotatable means. It also ensures that the mesh, and hence drive force created by the relative movement, is maintained to ensure optimum efficiency of energy transfer.

In one embodiment the invention, two sets of rotatable means are provided to be driven by the movement along each said rack face, each of said rotatable means connected to drive an output shaft.

Typically, each of the output shafts driven by the said pair of rotatable means, is driven to rotate in an opposing direction with the rotation of the respective shafts being electrically connected to provide the generation of electric power.

In a further embodiment a first rack member is provided which includes two rack faces and a second rack member is provided in the same apparatus which includes two rack faces and at least one rotatable means is provided to move along each of the rack faces. Typically the rack members are provided in connection with a common energy generating system.

In one embodiment of the apparatus the connection between the rotatable means and the electrical power output shaft, includes a unidirectional clutch and a step up gear assembly so as to increase the rate of rotation of the output shaft as a result of the relative movement between the rotatable means and the rack.

In one embodiment the assembly includes first and second rack members each with two opposing rack or teeth faces, and wherein rotatable means are provided to contact with each of the said rack faces and drive a common gear wheel. Typically the arrangement is that of an epicyclic gear wheel, which in turn is connected to drive at least one output shaft from which electricity can be generated.

In one embodiment, the rotatable means are provided as part of an assembly with relative movement between the assembly and said rack faces, said rack faces being located within a housing, said housing including and retaining therein, a lubricant.

Typically, the assembly and housing are provided in a fixed position and the rack member moves relatively to the assembly within the housing such that when the rack moves downwardly towards the base of the housing, the rack displaces the lubricant and gears and lubricates the same.

Typically, at least some of the lubricant is carried by the teeth of the rack such that the lubricant passes onto the assembly to lubricate other components of the assembly.

In one embodiment, the housing is also provided above the said assembly so as to form a substantially sealed housing in which the rack is located. Typically, the portion of the housing protruding above the assembly is longer than the maximum reach of the top portion of the rack from the assembly thereby ensuring that the said rack is always accommodated within the housing.

Alternatively, the housing may include a portion which can selectively expand or move to accommodate movement of the rack with respect to the assembly. In one embodiment the portion can be a gator.

In one embodiment, at the interface between the rack and a transfer shaft, a larger portion of the housing in which the rack is located is provided, said larger portion including a bearing material to provide a sliding bearing for support and guidance for the rack and the shaft. This ensures that the loads applied to the rack are transferred directly up and down and hence prevent buckling of the rack member.

Typically, the said larger portion has apertures formed therein to allow oil to flow through the same when the oil in the tube is displaced by a sufficient amount. The holes then allow for the lubricant to flow back down the rack providing a further source of lubrication.

In a further aspect of the invention there is provided apparatus for creating electrical power from movement of a body of water, said apparatus comprising a float portion which is movable under the influence of the body of water and a mounting portion which is also moveable under the influence of the body of water wherein, the mounting portion is provided with means to prevent excessive movement of the float portion.

This particular arrangement is provided to be of use to allow the apparatus to react to tidal fluctuations of the body of water so as to ensure that, within a given range, the float is located in the optimum position with regard to the body of water, whilst ensuring that the apertures in the float portion is not allowed to more excessively under the influence of a body of water which is moving excessively.

The apparatus is typically provided to ensure that the float is not carried above the surface of the body of water.

In a further aspect of the invention, there is provided apparatus for generating electrical power as a result of the movement of a body of water, said apparatus including a connection to a generator, the operation of which is achieved by the rotation of at least one shaft connected thereto, said at least one shaft rotated by movement of the apparatus as a result of movement of the body of water, and wherein monitoring means are provided at the generator to monitor the load on the generator and, if said load exceeds a predetermined level, then one or more resistors are activated to provide a mechanical brake to prevent mechanical overload of the generator.

In one embodiment of the invention, the apparatus uses a gear system which converts linear motion in both directions to rotational motion in a single direction, by using a series of gears and clutches as described. In one embodiment the linear motion is derived by the action of a buoy mounted around a stable column situated in a body of water. As the body of water moves up and down due to the action of waves so does the buoy with the action of the buoy being transferred to the central column and on to the system inside the column as described. The rotational motion is converted in to electrical energy by the use of an alternator.

Typically, in order to synchronize with the electrical network or grid which is to be provided with the electricity which is generated by the apparatus a regenerative drive is used. Typically, the regenerative drive consists of inverters, one of which is connected to the alternator and one of which is connected to the grid. Typically a dc connection is provided between the 2 inverters which includes a capacitor bank.

The capacitor bank has the facility to hold an amount of charge above the level that is being transferred to the grid through the line side inverter providing effectively a small reservoir of electrical energy.

In one embodiment, multiple devices may be connected to a common DC bus which links all the WEC's, which ultimately link with a single line side inverter/controller. This helps reduce losses within a typical array and still allows individual control of the WEC's.

In a further embodiment of the invention the apparatus is provided with a means to allow the tidal variation of the body of water in which the apparatus is positioned to be taken into account. In one arrangement the central column is allowed to move to its mean floating position while maintaining a stable platform for a further buoy to react against. The operation of the further buoy in any given wave condition transfers forces due to hydrodynamic reaction and gravity on to a connecting rod through to an internally mounted energy conversion device housed in the central column.

Typically the Energy conversion device converts the force and movement (linear) into single direction rotational motion through its rack and gear system, (torque and rotation) which is converted into electrical energy by means of a permanent alternator or in the case of the double sided gear system 2 PMA's.

Typically the resistance to movement and force that is required to prevent the movement of the central column moving in unison with the external buoy is achieved by the provision of a plate or poppet valve arrangement that closes the valves upon the occurrence of sharp increases in pressure due to the initial force exerted on the system as the buoy moves in reaction to relatively quick changes in water height (Waves).This forms a sufficient seal between the piston to allow the hydraulic pressure within the chamber to resist the system from moving.

In a further aspect of the invention there is provided apparatus for the monitoring of movement of a body of water, said apparatus including a monitoring head located for use above the body of water, said head provided with means to generate an ultrasonic signal from the head to the body of water, receiving means to receive a reflected signal back from the body of water, said signals being transmitted at predetermined time intervals such that monitoring and processing of the reflected signals received allows a wave profile of the body of water to be generated over time.

In one embodiment, the said ultrasonic signal is generated a number of times a second.

In one embodiment, the apparatus includes transmitting means to allow data representative of the transmitted and received signals to be transmitted to a remote location for processing and analysis.

In one embodiment, on the basis of the data received, a prediction of energy which can be produced using the apparatus of the current invention in said body of water can be generated.

Typically, on the basis of the prediction, a decision can be made as to whether or not the use of the apparatus of the invention in said body of water is viable.

In a further aspect of the invention apparatus is provided to detect the condition of a body of water, said apparatus comprising a housing provided to float at or adjacent to the surface of the body of water, said apparatus including sensing means in the form of an accelerometer and one or more tilt sensors, said sensing means generating data representative of a change in condition of the accelerometer and/or tilt sensors, and said data processed and analysed to generate a wave profile of said body of water.

In a further embodiment of the invention there is provided apparatus for creating electrical power from movement of a body of water, said apparatus comprising a float portion which is movable under the influence of the body of water and a mounting portion which is selectively moveable under the influence of the body of water wherein, when in use to generate electricity relative movement occurs between the float portion and the mounting portion and, when at least one parameter with respect to the condition of the body of water exceed a predetermined level the relative movement between the float and mounting portions is prevented.

Typically the one or more racks are formed on the mounting portion and the one or more pawls are provided on the float portion.

In one embodiment the at least one parameter is the fact that the waves are excessively high and therefore the relative movement between the float and mounting portions would be too great.

Specific embodiments of the invention are now described with reference to the accompanying drawings; wherein

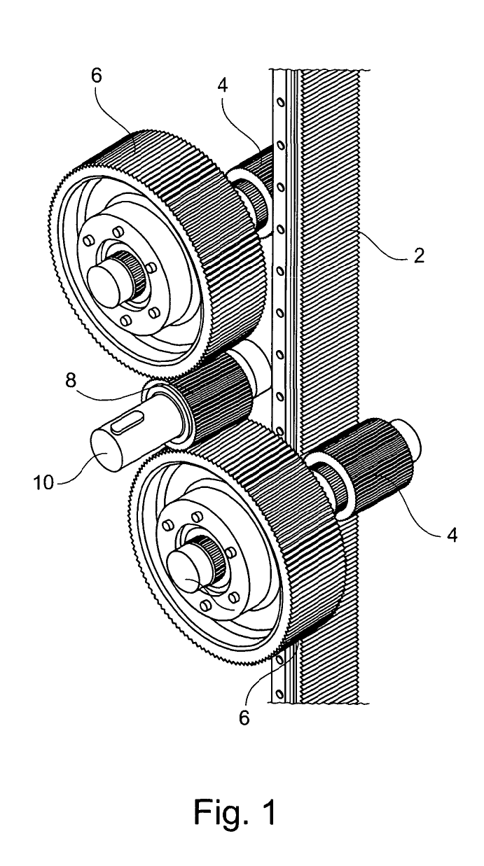

FIG. 1 illustrates the rack and rotatable system in accordance with one embodiment of the invention in a single arrangement;

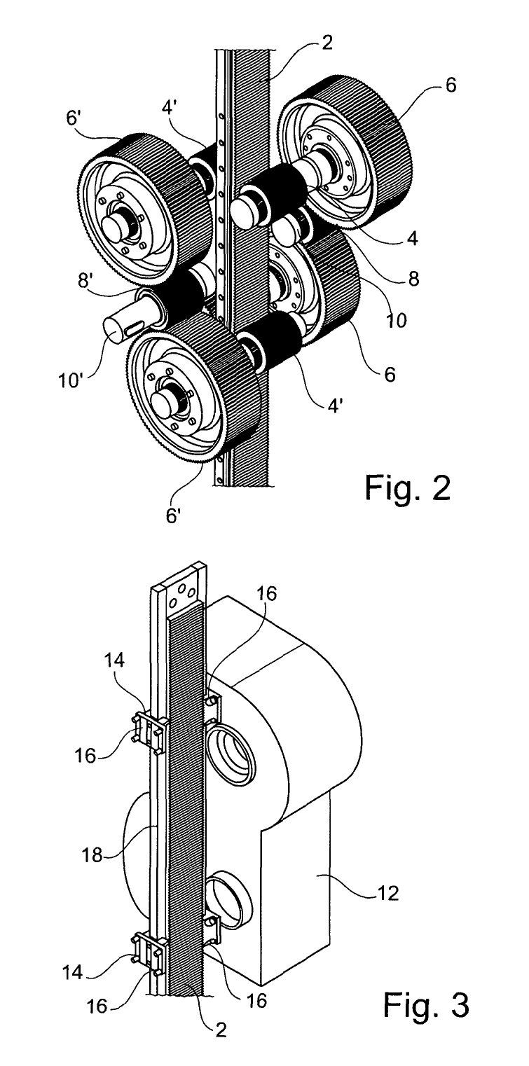

FIG. 2 illustrates the rack and rotatable means system in accordance with a second embodiment of the invention in a double arrangement;

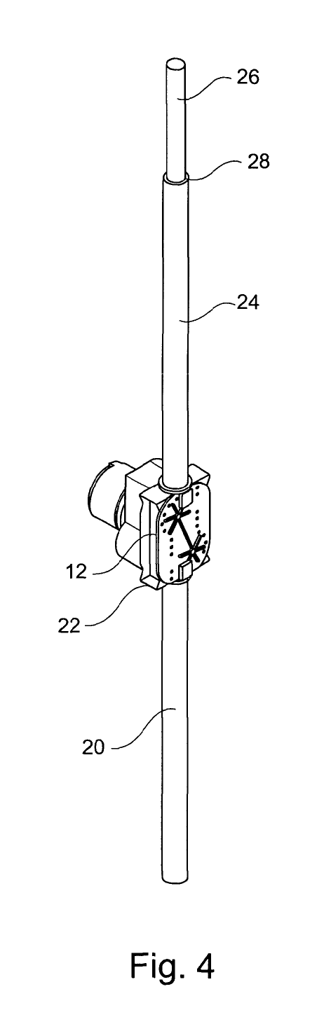

FIG. 3 illustrates the linear guide arrangement which is provided to ensure controlled movement between the rotatable means and the rack;

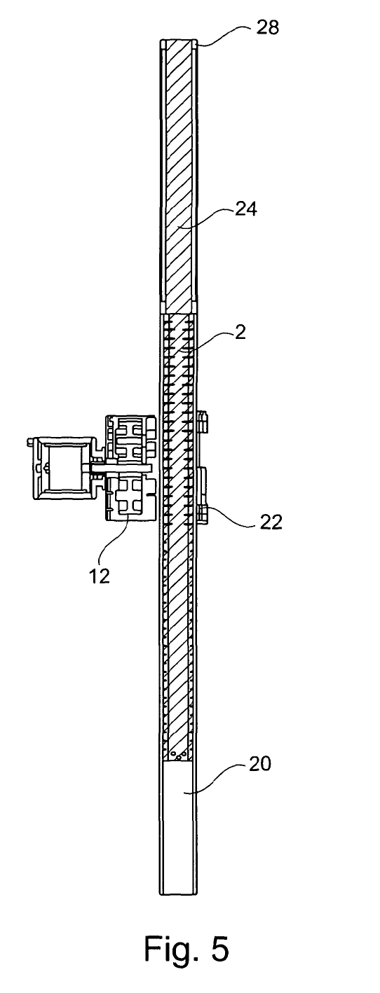

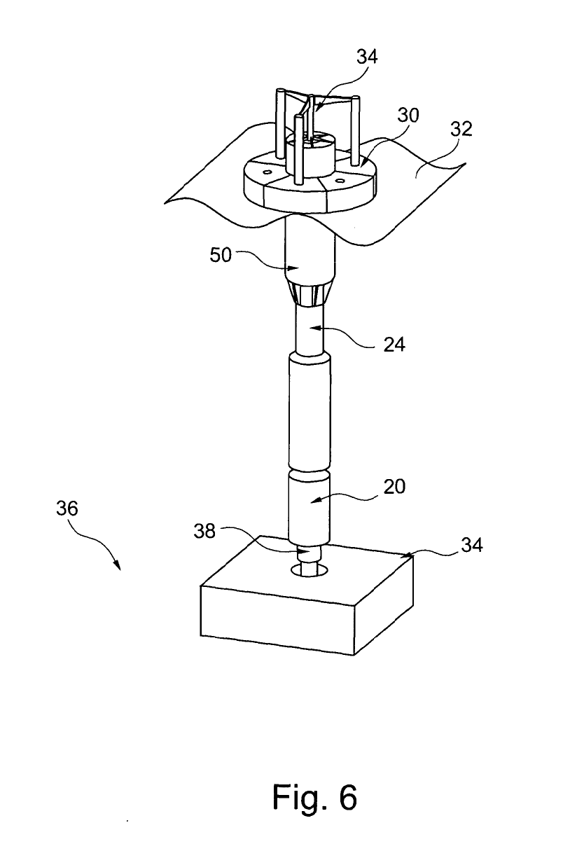

FIGS. 4 and 5 illustrate a housing assembly in accordance with the invention;

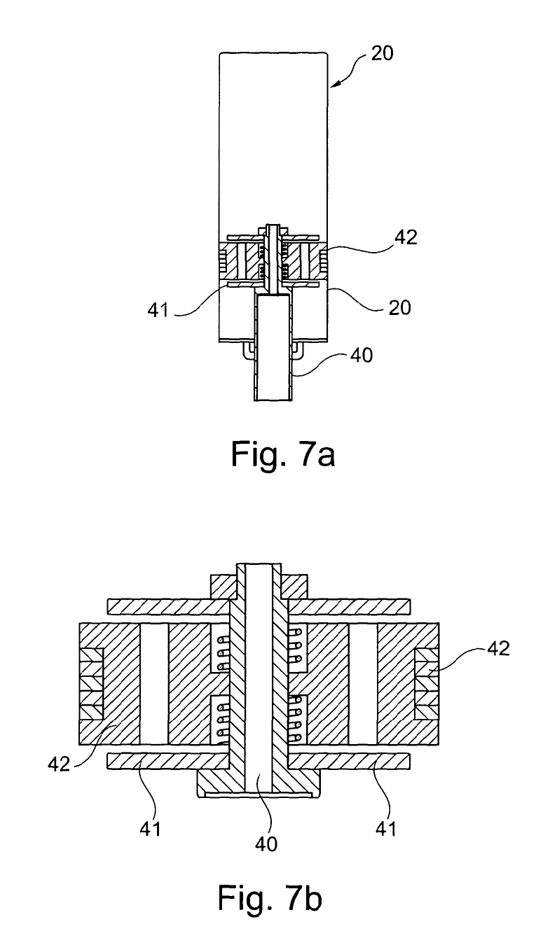

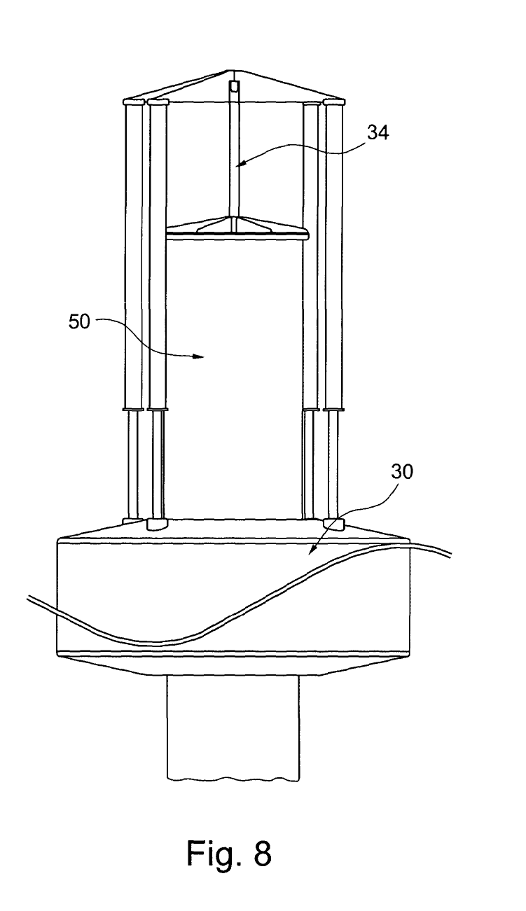

FIGS. 6 and 7a and b illustrate an embodiment of apparatus in accordance with the invention provided to control the effect of the movement of the body of water;

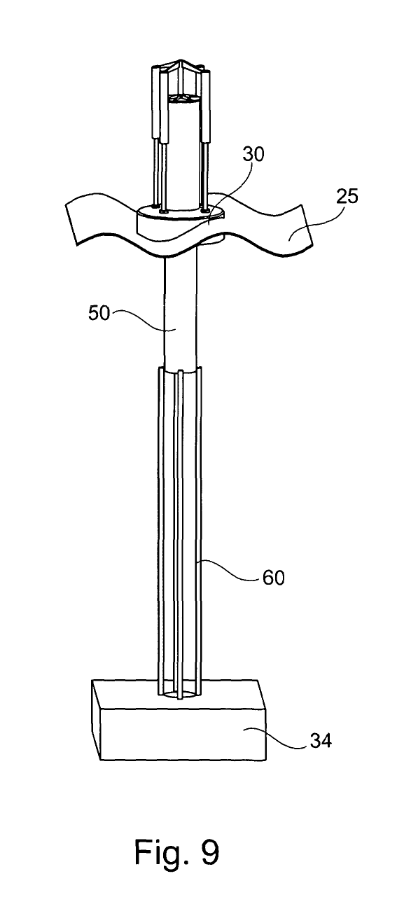

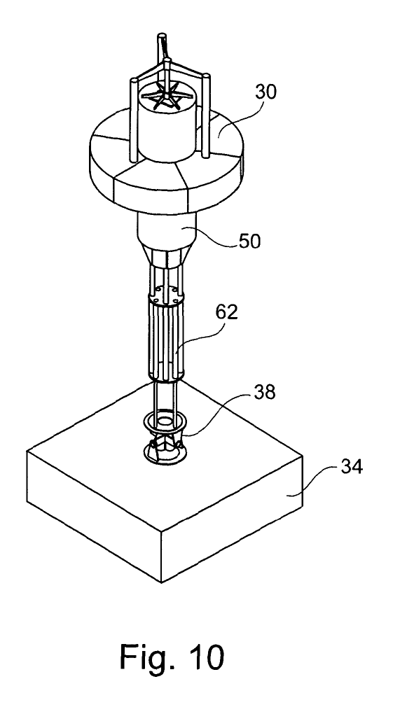

FIGS. 8 and 9 illustrate a further embodiment of apparatus in accordance with the invention provided to control the effect of the movement of the body of water;

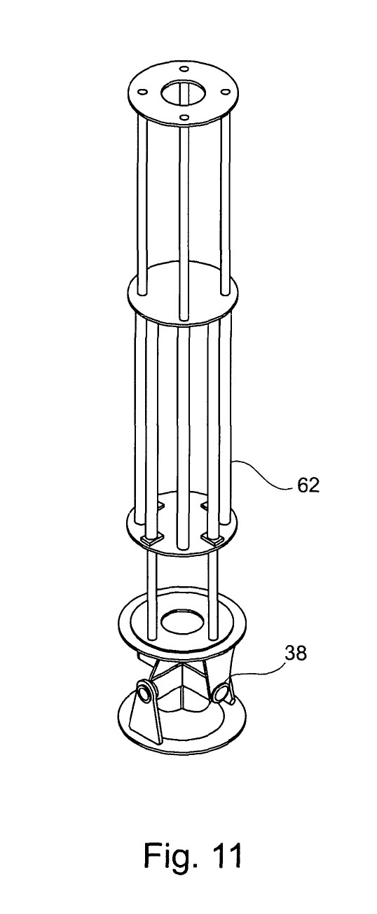

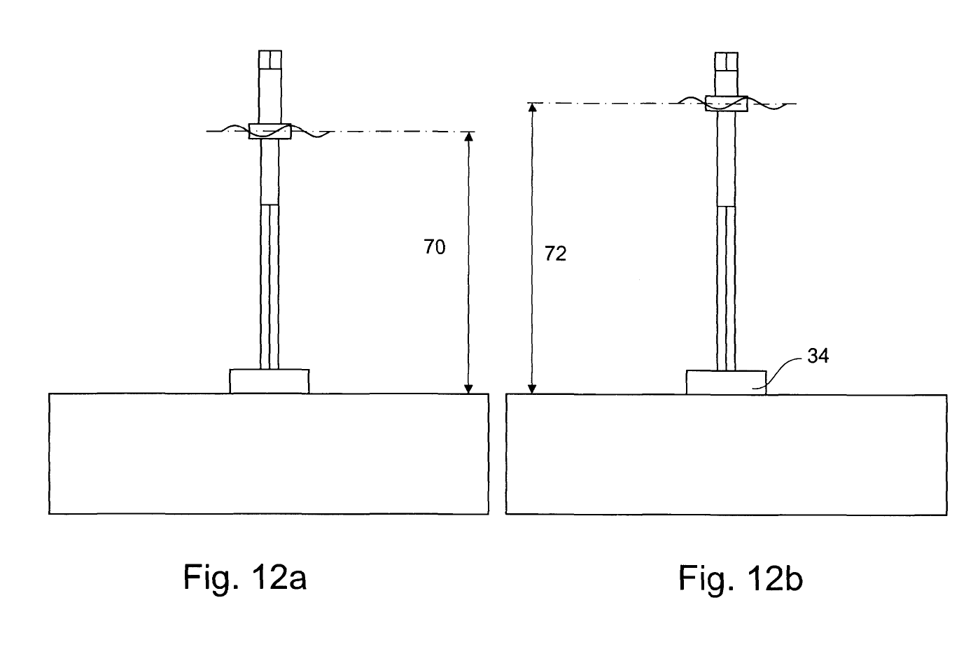

FIGS. 10 and 11 illustrate a further embodiment of apparatus in accordance with the invention provided to control the effect of the movement of the body of water; and

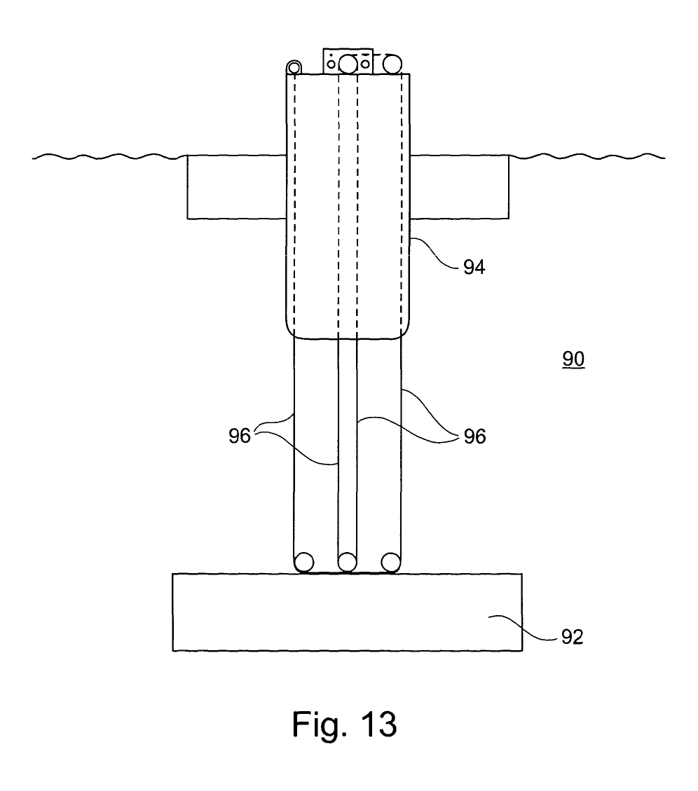

FIGS. 12a and b illustrate apparatus in accordance with the invention in different body of water conditions respectively

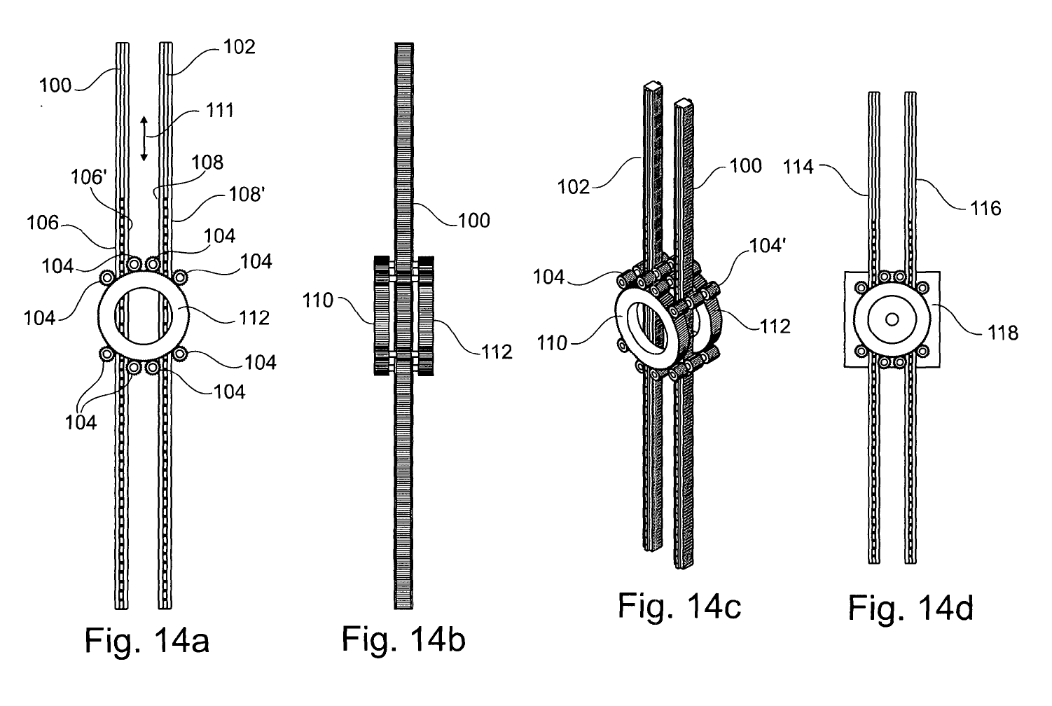

FIG. 13 illustrates a further arrangement for the support apparatus for the rack and pawl power generation apparatus

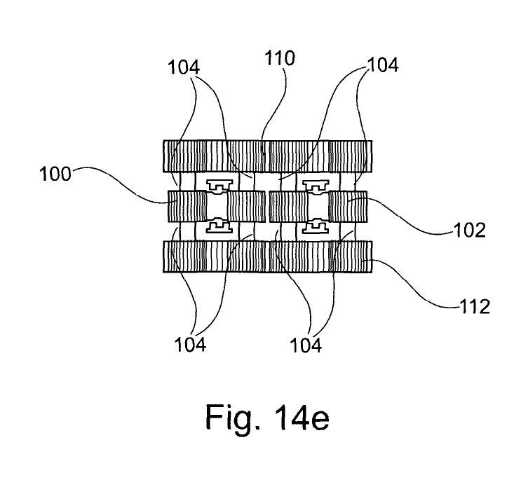

FIGS. 14a-e there are provided views of a further power generating embodiment in accordance with the invention.

FIGS. 1 and 2 illustrate first and second embodiments of the invention and both of which show a rack member 2 with teeth two racks which are provided to engage with rotatable means in the form of pawls which rotatably move with respect to the rack 2.

In FIG. 1, a pawl 4 is provided on the racks on opposing sides of the rack member 2 and each respective pawl is provided to drive a wheel 6 which mesh with the gear wheel 8 so as to provide drive on a shaft 10 which is connected to generate electricity.

Typically, the pawls and wheels 6 are provided such that movement of the assembly in a first direction such as upwardly, causes rotation of the shaft 10 and movement of the same downwardly in the vertical direction along the rack also causes rotation of the shaft 10 in the same rotational direction. This allows rotation of the shaft and hence generation of electricity, to be achieved under the influence of a body of water which is moving upwardly and downwardly such as, for example, caused by the waves of the sea.

Typically, at least either the rack member, or the pawls and wheel assembly, are mounted on a float which is provided to move under the influence of the body of water, with the other of the rack and pawls and wheel assembly held in a fixed position, or in a more restrained position with respect to the float.

FIG. 2 illustrates a further embodiment of the invention in which there is provided a first pawl and wheel assembly with pawl 4′, wheel 6′, gear wheel 8′, and shaft 10′ provided in a similar manner to that described in FIG. 1 and a second pawl and gear wheel assembly with pawl 4, wheel 6 and gear wheel 8 provided on the opposing side of the rack member from the first assembly. Once again, the movement of the second assembly causes rotation of a shaft 10 so as to allow electricity to generate therefrom. Thus, in this arrangement, the same rack member, 2 is used to provide a movement path for two electricity generating assemblies in the similar manner to that shown in FIG. 1. In a yet further embodiment, not shown, two rack members can be provided in the same apparatus, each rack member having two racks with a wheel and pawl assembly meshed therewith.

FIG. 3 illustrates a housing 12 in which is located one of the pawl and wheel assemblies (not shown). The housing is provided in location with the rack 2 and is also shown is the provision of guide means 14 at spaced locations along the pawl 2 and which guide means are secured to the housing 12 so as to allow smooth and guided movement of the housing (and hence pawl and wheel assemblies within the housing) along the rack member. The guide means are provided in the form of bearings 16 located on each side of the rack member and which engage with tracks 18 located on the rack member. It is found that this improves the efficiency of movement and ensures that the pawls engage correctly with the teeth of the rack member.

Turning now to FIGS. 14a-e there is illustrated a further drive arrangement in accordance with the invention. In this case there are provided two rack members 100, 102, each having two rack faces 106,106′ and 108, 108′ respectively. As shown a rotatable means or pawl 104 are provided to engage each of the rack faces 106,106′ 108,108′, in this case with two pawls 104 contacting each of the rack faces and the pawls 104 will move up and down the rack faces due to the relative movement which is achieved under the influence of the movement of the body of water in the manner described previously such that the rack members or pawls are held in a relatively fixed position and the other of the rack members or pawls are movable under the influence of the movement of the body of water. The pawls 104 are located with respect to annular gear wheels 110, 112, typically in an epicyclical manner and which gear wheels are, in turn, connected to drive one or more output shafts which can be connected to electricity generating apparatus. In this arrangement the two racks 100, 102 convert the linear motion indicated by arrow 111 of the body of water to the rotational movement via the pawls 104. The pawls typically each include a sprag clutch such that in a first direction of relative linear movement the pawls 104 on one side of the rack members create a drive and free wheel in the reverse direction of linear movement and the pawls 104′ on the opposing side of the rack members perform in the reverse manner in that they free wheel in the first direction of relative linear movement and create a drive in the reverse direction of linear movement such that a drive effect is created in both direction of linear movement of the rack members. By providing the eight pawl assemblies with the annular gear wheel so the load is spread and therefore increases the power output. Typically the rack and gears are provided in respective casings 114, 116, 118 as shown in FIG. 14d thereby allowing protection and permit oil lubrication to be provided within the casings.

FIGS. 4 and 5 illustrate an arrangement of apparatus in accordance with one embodiment of the invention in which the rack member 2 is housed within an outer housing 20 underneath the gear and pawl assembly 12 and a further casing 22 is provided which encloses the guide means on the rack and also the pawls and rack teeth themselves at the location of contact. Above the casing 22 there is provided an upper housing 24 in which the upper part of the rack member is housed such that the rack member is effectively encased, and thereby protected, from inclement weather conditions and/or the effects of contact with the body of water. This therefore further ensures the smooth operation of the apparatus.

In this case, typically the rack member is movable within the housing 20, 24 and is moved under the influence of the body of water, with the housing 12 being held in a fixed or restrained location.

Typically, in the lower housing 20, there is provided a lubricant material which is of sufficient depth so that the rack picks up some of the lubricant material when in its lower position and then, when moved to a raised position, the lubricant is transferred from the teeth of the racks onto the pawls and hence lubricates the same.

Furthermore, there is provided a seal 28 between the housing 24 and the shaft 26 which acts to provide support and ensure that loads applied to the rack via the transfer shaft are applied in the same longitudinal plane as the rack and therefore prevents buckling of the same. Apertures may also be selectively provided to allow lubricant which has been carried by the rack into the housing 20 and 24, and which is excess to requirements, to pass back down into the lower portion of the housing 20 and therefore provide a further lubrication source.

FIG. 6 illustrates an assembly of apparatus in accordance with the invention in which there is provided a buoyancy chamber 30 which is located to be acted upon by the body of water 32 to move in upwards and downwards directions. The buoyancy chamber 30 is connected to a transfer shaft 34 which passes through a cavity in the buoyancy chamber to contact with the rack member in the manner previously described in FIGS. 4 and 5 so as to move the rack member under the influence of the water. The pawl and gear assembly 12 is connected and located within the column 50 and in turn to a gravity base 34 at the sea bed 36 via a universal joint 38. The provision of this arrangement ensures that relative movement between the pawl and gear assembly and rack member is achieved in a controlled manner such as to allow the generation of power. However, in addition the provision of the buoyancy chamber and the connection of the components in relation thereto, ensures that any rapid or shock movement which could be caused, by example, due to storm force conditions is prevented and the apparatus is effectively locked, thereby preventing the rapid movement being transferred to the connection between the rack and the pawl and thereby prevents the same from being damaged.

FIGS. 7a and b illustrates the cylinder 20 of FIG. 6 and illustrates how there is provided within the same, a movement mechanism connected to the rod 40 which in turn is connected to the universal joint 38. The cylinder includes within the same, a piston and valve arrangement 42 which is provided to be selectively movable within the cylinder within the vertical direction. The provision of the pistons and valve plates 41, means that variations in the body of water can be taken into account, such as, for example, to reflect tidal conditions, without affecting the overall operation of the apparatus. Also, if there is rapid movement of the apparatus due to rapid fluctuations in the body of water the valve plates 41 of the cylinder will close and thereby prevent any further relative movement between the rack and pawl. Typically, in operation, the gravity base 34, a buoyancy chamber 30, cylinders 20 and 24 can be assembled in a safe environment such as a harbour and then towed out to the deployment location during a suitable weather window. The gravity base 34 can be ballasted to sit on the sea bed and the buoyancy chamber 30 is provided at the correct position with regard to the surface of the body of water and the column 50 is supported by tube and cylinder 24, 20 at the height for the gear and wheel assembly 12 to be positioned on the rack member within the same as it moves under the influence of the buoyancy chamber. In operation, tidal variation is facilitated by the provision of the pistons and valves in the cylinder 20 which allow the apparatus to retain its correct water height for operation. In operation, the rack and pawl and gear wheel assemblies 12, are located within the column 50 and the motion of the buoyancy chamber 30 moves the rack member up and down due to its reaction to the change of water level and gravity as the waves move past the same. The movement of the buoyancy chamber is transferred to the rack via the transfer shaft 34.

FIGS. 8-11 illustrate further embodiments of the apparatus shown in FIGS. 6 and 7. Hydraulic rams can be used to form the connection between the buoyancy chamber 30 and the wave energy conversion device in the column 50 so as to allow the buoyancy chamber to adjust to optimum position with respect to the water surface 25 by means of opening and closing valves in the hydraulic circuit. The circuit can be controlled by monitoring variation in the operation of the rack member within the wave energy conversion device and, over a period of time, to allow the preferred position of the pawl on the centre of the rack at a datum point to be found. The hydraulic system will rely on the force of the buoyancy chamber 30 due to buoyancy to close the rams then gravity to extend the rams.

In FIG. 9, the central column 50 has a positive buoyancy which puts tethers or chains 60 in constant tension. The tethers and chains are formed and the buoyancy is such that, at low water level, the tethers and chains are in constant tension under the force that the buoyancy chamber can apply to the apparatus and hence the central column 50, as the buoyancy chamber falls as the water height recedes due to the action of the wave passing by it.

In FIGS. 10 and 11, there is shown the layout of a further embodiment of the system wherein the hydraulic rams 62, are provided in a subsea location. The central column 50 has sufficient buoyancy to allow it to ride to the mean water preset level using ballast and hence allow the same and the pawl and gear assembly 12 housed within it to be constantly at its mean water height. The hydraulic system shown in FIGS. 10 and 11 creates resistance by holding the central column 50 in place. The hydraulic system 62 periodically allows the valves within the system to open and close to allow the rams to extend due to increase in water height over a period of time or to allow the rams to contract due to decreasing the mean water height. The rams on the top of the assembly 62 are facing up and the rams on the bottom are facing down and overlap to decrease the overall length of the system and also to allow maximum length, whilst minimising the potential buckling force associated with the hydraulic rams. It should also be noted that at the bottom of the hydraulic arrangement there is a universal joint 38 which allows the device to flex in operation, therefore minimising forces and increasing survivability whilst also allowing the overall system to function at its optimum. Although a universal joint is shown, it is possible for the system to function without it and in certain circumstances it can be an advantage not to employ this with the central column held at its optimum position in the water so the buoyancy chamber 30 and rack member supported thereby can move with respect to the same under the influence of the wave movement.

Turning now to FIGS. 12a and b, in this case, the gravity bed is provided in a reinforced concrete structure 34 which has chambers within it. The gravity bed is of sufficient weight that when it is submerged, it has sufficient mass to resist the maximum force exerted by environmental conditions so as to remain in place. The chambers within the gravity base 34 are full of air at normal atmospheric pressure and this allows the gravity base to be buoyant and therefore it can be towed into place and, when the valves are opened, water flows in and the device sinks into place. The subsea chamber 64 provides sufficient buoyancy to allow any of the apparatus assemblies as previously described, to be provided in position. FIGS. 12a and b illustrate the apparatus in position on the seabed and illustrate how the height of the apparatus can vary with regard to the water level between the low tide 70 and high tide 72.

Referring now to FIG. 13 there is provided a further embodiment of support apparatus for the rack and pawl power generation apparatus in the body of water 90. In this case there is provided a base 92 which is provided with ballast so as to exert a sufficient downward force on the apparatus so as to allow relative movement between the pawl mounted with respect to the float 93 and the rack within the mounting chamber 94 and which is held in position with respect to the base. In this case the base 92 is connected to the chamber 94 via pulleys or tethers 96 which are adjustable, typically by motor, so as to allow suitable adjustment of the distance between the base and the remainder of the apparatus and when in position held in tension so as to hold the mounting chamber in a relatively fixed position with respect to the float 93 to thereby allow relative movement of the same under the influence of the body of water. In normal operation conditions the pawls are therefore moveable in a substantially vertical direction under the influence of the movement of the body of water with respect to the rack (not shown) and base and electricity can be generated as described previously. However should the movement become too great or too fast the tethers can be released from tension and this thereby allow the chamber 94 to also float along with the float assembly 93 and therefore there is no relative movement between the rack and pawl.

It should be appreciated that any one, or combination, of these improvements can be used to allow improved operation of the apparatus as herein described.

1. Apparatus for generating power from the movement of a body of water, said apparatus including a first member provided to be located at, or close to, the surface of the body of water, at least one rotatable means provided for movable engagement with at least one rack member wherein one of the rotatable means or rack is connected with said first member to move under the influence of the same and to move with respect to the other of the rotatable means or rack to create a driving force and/or create power, said rack member including at least first and second rack faces, and a plurality of rotatable means are provided to move along and engage with each of said rack faces, said rotatable means connected to a gear assembly such that movement along the rack faces in a first direction causes at least one of the gears to drive an output shaft and movement in the opposing direction causes at least one of the gears to drive an output shaft wherein the output shaft or shafts are connected to create electrical power.

2. Apparatus according to claim 1 wherein the gear assembly includes one or more clutches.

3. Apparatus according to claim 1 wherein linear guide means are provided at or adjacent to one or both of said rack faces, said guide means provided to maintain the correct tooth meshing position between the rotatable means and said rack faces during relative movement of the same.

4. Apparatus according to claim 1 wherein the linear guide means are provided on opposing sides of each of said rack faces and match with guide followers provided to act in conjunction with the rotatable means.

5. Apparatus according to claim 1 wherein two sets of rotatable means are provided to be driven by the movement along each said rack face, each of said rotatable means connected to drive an output shaft.

6. Apparatus according to claim 5 wherein each of the output shafts driven by the said pair of rotatable means, is driven to rotate in an opposing direction with the rotation of the respective shafts being electrically connected to provide the generation of electric power.

7. Apparatus according to claim 1 wherein a first rack member is provided which includes two rack faces and a second rack member is provided in the same apparatus which includes two rack faces and at least one rotatable means is provided to move along each of the rack faces.

8. Apparatus according to claim 7 wherein the rack members are provided in connection with a common energy generating system.

9. Apparatus according to claim 7 wherein rotatable means are provided to contact with each of the said rack faces and are mutually positioned to drive a common gear wheel.

10. Apparatus according to claim 9 wherein the gear wheel which is driven in annular.

11. Apparatus according to claim 1 the connection between the rotatable means and the electrical power output shaft, includes a unidirectional clutch and a step up gear assembly so as to increase the rate of rotation of the output shaft as a result of the relative movement between the rotatable means and the rack.

12. Apparatus according to claim 1 wherein the rotatable means are provided as part of an assembly with relative movement between the assembly and said rack faces, said rack faces being located within a housing, said housing including and retaining therein, a lubricant.

13. Apparatus according to claim 12 wherein the assembly and housing are provided in a fixed position and the rack member moves relatively to the assembly within the housing such that when the rack moves downwardly towards the base of the housing, the rack displaces the lubricant and gears and lubricates the same.

14. Apparatus according to claim 13 wherein at least some of the lubricant is carried by the teeth of the rack such that the lubricant passes onto the assembly to lubricate other components of the assembly.

15. Apparatus according to claim 12 wherein the housing is located above the said assembly so as to form a substantially sealed housing in which the rack is located.

16. Apparatus according to claim 14 wherein the portion of the housing protruding above the assembly is longer than the maximum reach of the top portion of the rack from the assembly thereby ensuring that the said rack is always accommodated within the housing.

17. Apparatus according to claim 12 wherein the housing includes a portion which can selectively expand or move to accommodate movement of the rack with respect to the assembly.

18. Apparatus according to claim 12 wherein at the interface between the rack and a transfer shaft, a larger portion of the housing in which the rack is located is provided, said larger portion including a bearing material to provide a sliding bearing for support and guidance for the rack and the shaft.

19. Apparatus according to claim 18 wherein the said larger portion has apertures formed therein to allow oil to flow through the same when the oil in the tube is displaced by a sufficient amount.

20. Apparatus for creating electrical power from movement of a body of water, said apparatus comprising a float portion which is movable under the influence of the body of water and a mounting portion which is also moveable under the influence of the body of water wherein, the mounting portion is provided with means to prevent excessive movement of the float portion.

21. Apparatus for generating electrical power as a result of the movement of a body of water, said apparatus including a connection to a generator, the operation of which is achieved by the rotation of at least one shaft connected thereto, said at least one shaft rotated by movement of the apparatus as a result of movement of the body of water, and wherein monitoring means are provided at the generator to monitor the load on the generator and, if said load exceeds a predetermined level, then one or more resistors are activated to provide a mechanical brake to prevent mechanical overload of the generator.

22. Apparatus according to claim 21 wherein the apparatus uses a gear system which converts linear motion in both directions to rotational motion in a single direction.

23. Apparatus according to claim 22 wherein the linear motion is derived by the action of a buoy mounted around a stable column situated in a body of water and the rotational motion is converted in to electrical energy by the use of an alternator.

24. Apparatus according to claim 23 wherein in order to synchronize with the electrical network or grid which is to be provided with the electricity which is generated by the apparatus a regenerative drive is used including inverters, one of which is connected to the alternator and one of which is connected to the grid.

25. Apparatus according to claim 1 wherein the apparatus is provided with a means to allow the tidal variation of the body of water in which the apparatus is positioned to be taken into account said apparatus including a central column which is allowed to move to its mean floating position while maintaining a stable platform for a further buoy to react against, said further buoy in any given wave condition transfers forces due to hydrodynamic reaction and gravity on to a connecting rod through to an internally mounted energy conversion device housed in the central column.

26. Apparatus according to claim 1 wherein the apparatus includes a float portion which is movable under the influence of the body of water and a mounting portion which is selectively moveable under the influence of the body of water wherein, when in use to generate electricity, relative movement occurs between the float portion and the mounting portion and, when at least one parameter with respect to the condition of the body of water exceeds a predetermined level the relative movement between the float and mounting portions is prevented

27. Apparatus for creating electrical power from movement of a body of water, said apparatus comprising a float portion which is movable under the influence of the body of water and a mounting portion which is selectively moveable under the influence of the body of water wherein, when in use to generate electricity relative movement occurs between the float portion and the mounting portion and, when at least one parameter with respect to the condition of the body of water exceed a predetermined level the relative movement between the float and mounting portions is prevented

28. Apparatus for the monitoring of movement of a body of water, said apparatus including a monitoring head located for use above the body of water, said head provided with means to generate an ultrasonic signal from the head to the body of water, receiving means to receive a reflected signal back from the body of water, said signals being transmitted at predetermined time intervals such that monitoring and processing of the reflected signals received allows a wave profile of the body of water to be generated over time.

29. Apparatus according to claim 28 wherein, on the basis of the data received, a prediction of energy which can be produced using the apparatus of the current invention in said body of water can be generated and on the basis of the prediction, a decision can be made as to whether or not the use of the apparatus of the invention in said body of water is viable.
